(19) United States
(12) Patent Application Publication
(10) Pub. No.: US 2019/0263289 A1
(43) Pub. Date: Aug. 29, 2019

(54) Emergency responder traffic signal power supply

(71) Applicant: Horsepower Electric Inc., Hialeah, FL (US)

(72) Inventor: Hector P. Ortiz, Hialeah, FL (US)

(21) Appl. No.: 16/286,674

(22) Filed: Feb. 27, 2019

Related U.S. Application Data
(60) Provisional application No. 62/635,802, filed on Feb. 27, 2018.

(51) Int. Cl. B60L 55/00; G08G 1/087; G08G 1/097; G08G 1/095

(52) U.S. Cl. CPC B60L 55/00; G08G 1/095; G08G 1/097; G08G 1/087

(57) ABSTRACT

Disclosed is a power supply in combination with a first responder vehicle for use in providing power to traffic signals. The power supply is based upon a vehicle having an internal combustion engine and an electrical system capable of producing 12 VDC. A 5000 W inverter is electrically coupled to the electrical system through the use of a battery bank to modulate the current. A power transfer cord is securable to the inverter and the traffic signal, wherein the engine of the police vehicle operates as an electrical generator, providing an alternative power source for a traffic signal during times of power outages.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 62/635,802, entitled “EMERGENCY RESPONDER TRAFFIC SIGNAL POWER SUPPLY”, filed Feb. 27, 2018. The contents of which the above-referenced application is incorporated herein by reference in its entirety.

### FIELD OF THE INVENTION

This invention is related to traffic signals, and in particular, to a power supply that is installed in an emergency responder vehicle, such as a police car, to provide emergency power to traffic signals during a power loss.

### BACKGROUND OF THE INVENTION

Modern society has become conditioned on the use of traffic signals to control vehicles at most every intersection. When a loss of electrical power occurs, it becomes readily apparent that motorists have forgotten the basic rules of the road. Motorists may panic due to confusion or become aggressive if they believe another motorist has taken advantage of the situation. In any event, when traffic signals lose primary power, the risk of traffic accidents increase exponentially.

Police officers are routinely the first responders to reach an intersection having inoperative control lights. Trained to provide traffic control, the officer must leave the safety of his vehicle and inject himself into the situation by controlling the flow of traffic with hand signals. The officer stands in the middle of the intersection, placing himself in danger of being struck by a passing motorist. Further, standing outside, the police officer is subject to the elements, including rain, snow, sleet, hot sunlight or a moonless night.

In situations of mass power outages, such as during the aftermath of a hurricane, the risk to the officer is even greater due to the naturally occurring public panic. Loss of daylight can make a situation even more dangerous for the police officer who may need to rely upon flashlights, flares, or chemiluminescent lightsticks to highlight hand signals.

For these reasons, most modern traffic intersections include transfer switches to allow the connecting of a portable generator to provide temporary power to the traffic signals. When there is a power outage, a city may employ hundreds of portable generators. Unfortunately, during times of extreme hardships citizens can become desperate and steal the generator fuel, if not the entire generator, is commonplace.

In many instances the need for power is absolutely immediate, such as the case with dangerous intersections. These situations require a first responder to work quickly to control the immediate situation from becoming dangerous. However, it is impractical for a first responder to carry a portable generator that may be used infrequently, if ever. It is well known that non-use of an internal combustion engine cause early deteoriation of hoses and premature engine wear if the contact parts such as cylinders are not lubricated. Non-use may also result in the gasoline becoming stale and the carburetor becoming clogged with varnish. Maintenance of emergency generators is expensive and does not guarantee that they will work when needed. In contrast, most first responder vehicles are used every day. For instance, a police vehicle may be in constant use by working through multiple shifts. Such a vehicle is well maintained and always ready for use. Alternatives to portable generators include:

U.S. Pat. No. 5,208,584 discloses the use of a backup controller for a traffic light. The disclosure converts battery supplied DC power into AC power through the use of an inverter. The disclosure teaches a device that automatically changes from alternating current to a continuous DC supply in case of failure, but is limited to the storage of the battery. The storage of a battery presents problems due to the finite life of a conventional battery.

U.S. Pat. No. 5,034,571 discloses a retractable power cord for use on AC power systems, such as a recreational vehicle. The power source permits the vehicle to provide AC power outside the vehicle.

U.S. Pat. No. 5,659,305 discloses a secondary traffic controller and power supply. The disclosure provides a system where a traffic signal controller is mounted in a vehicle for use in controlling traffic lights. Thus, what is lacking in the art is an inexpensive power supply for installation in a police vehicle that permits an officer to quickly attach a secondary 120 VAC power source to a traffic signal and remain within the safety of their vehicle, allowing the traffic lights to operate automatically.

### SUMMARY OF THE INVENTION

Disclosed is a power supply for use in combination with a first responder vehicle such as a police car. The power supply converts 12V Direct Current into 120V Alternating Current for providing power to traffic lights. A 300 amp alternator is affixed to the engine of the vehicle and an engine governor maintains an engine rpm speed to assure an amperage output of 20 amp or higher, and at least 100 volts to prevent the low voltage lockout that is integrated into late model traffic light control systems. The police vehicle is equipped with a 5000 W inverter, in combination with a battery bank to assure stabilized power to the inverter. The police vehicle includes an electrical outlet positioned on the outer surface of the vehicle for ease of coupling to an extension cord. Alternatively, the police car is equipped with a retractable cord.

The disclosed system further includes a cross-over switch for connecting the police vehicle to the traffic controller so as to prevent a back feed into the power grid. The system is designed to keep the officer out of the intersection and safely within the confines of the police vehicle.

Disconnection of a primary power source is performed by a manual transfer switch that couples the traffic signal to the primary power source. When the transfer switch is opened, the primary power source is disconnected from the primary power source and prevents accidental feedback should the primary power source be reconnected.

An objective of the instant invention is to equip a first responder's vehicle with the equipment necessary for powering of a traffic light during loss of the primary power source.

Still another objective of the invention is to provide a police vehicle with a power source which eliminates the need for a police officer to manually control an intersection.

Still another objective of the instant invention is to remove the policeman from an intersection so as to eliminate the possibility of human injury.

Still another objective of the instant invention is to restore the use of traffic signals as quickly as possible to restore the traffic pattern to the normal pattern.

Another objective of the instant invention is to permit the traffic controller to operate in accordance with preprogrammed instructions by providing sufficient power to the light signals and the light signal controller.

Still another objective of the instant invention is to provide a system that restores power to the entire light signal system to avoid use of the flasher or the like preprogrammed safe mode.

Yet still another objective of the instant invention is to teach the use of a cross-over switch to prohibit a back feed of power produced by the police vehicle into the power grid for the safety of line workers.

An advantage of the instant system is the elimination of the need for a police officer to manually direct traffic within an intersection.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE DRAWINGS

FIG. 1 is a pictorial view of a vehicle coupled to a transfer switch and traffic signal cabinet; and

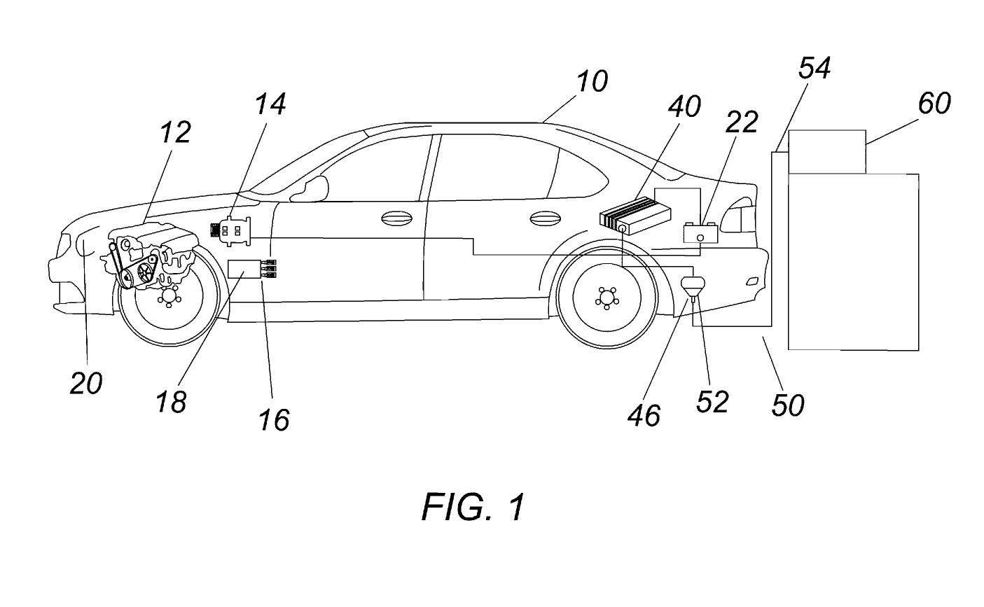

FIG. 2 is a block diagram depicting the components of the instant invention.

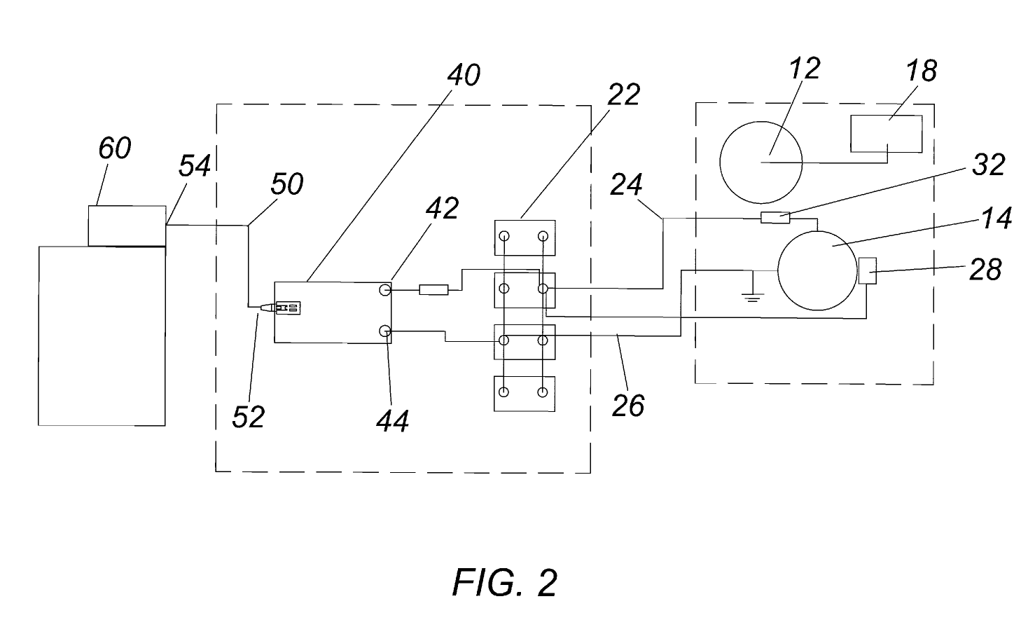

### DETAILED DESCRIPTION OF THE PREFERRED EMBODIMENT

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

Referring to the Figures, depicted is a power supply for traffic signals and a vehicle having an internal combustion engine. The internal combustion engine includes a 12 VDC 300 amp alternator 14 that replaces the conventional small output alternator typically found on a vehicle. A power controller 16 monitors the output of the alternator 14 as well as battery bank 22 condition and inverter 40 operation. The power controller 16 operates in conjunction with a governor to verify voltage and amperage outputs. It is noted that the amperage demands from traffic lights vary, some of the older traffic lights requiring upwards of 30 amps while newer LED based traffic lights may draw less than 15 amps. The governor 18 idles the engine to maintain the required voltage and amperage as required by a traffic light. Most all known traffic lights have independent controllers set to accommodate the local traffic, and should voltage or amperage drop below a predetermined level, the controller is bypassed and the street lights will simply flash on-off, indicating that the traffic light system is compromised. If the power controller 16 detects a low voltage or amperage output from the alternator 14, battery bank 22 or inverter 40, the power controller will initiate the sounding of the horn 20.

The battery bank 22 is electrically coupled to the alternator 14 by cables 24, 26, sized AWG 2/0. A voltage regulator 28 is attached to the battery bank 22 for controlling alternator 14 output to optimize the longevity of the battery bank 22. In the preferred embodiment, the battery bank 22 consists of four 12V batteries placed in parallel, thereby providing a 12V output with a higher storage capacity. The higher storage capacity assures a continuous flow of power to the inverter 40. Should the alternator fail to give a constant power flow due to engine RPM fluctuation or when peak demands are made by the traffic signals, the larger battery capacity will accommodate those variations in power. It should be noted that the vehicle is likely to handle other loads from the operator. For instance, the operator could be operating headlights, flashers, police emergency lights, and the like items, all of which can cause a draw upon the alternator 14, or which the larger battery bank 22 will accommodate. Conventional lead-acid batteries can be used. In addition, the battery bank can be placed in series with the engine battery, adding to its capacity or eliminating the need for a dedicated starting battery. As a safety element, a fuse 32 is placed in line with the alternator output.

The inverter 40 has a fused positive input 42 and a grounded negative input; the inverter converting from the battery output of 12 VDC to 120 VAC. In the preferred embodiment, the inverter 40 is rated for 5000 W to produce 120 VAC at about 30 amps. A 120 VAC plug 46 is located on an outer surface of the vehicle 10.

A power transfer cord 50 has a first end 52 securable to the inverter 40 and a second end 54 for securement to a traffic signal transfer switch 60. Alternatively, an extension cord may be associated with a retractable reel for ease of deployment and retraction of the second end 54. The transfer switch 60 is a positive disconnect from the primary power supply to the emergency responder traffic signal power supply. In operation, the power controller 16 works in combination with the governor 18 for adjusting the internal combustion engine 12 speed to maintain the inverter 40 output above 20 amps and 100 VAC. Operation beneath 100 VAC can be detrimental to the longevity of the traffic signal lights, and most systems include an independent low voltage sensor that forces the light signal to flash when insufficient voltage is available. In the preferred embodiment, low voltage or low amperage conditions are detected by the power controller 16 and are used to initiate an audible alarm using the car horn 20.

Newer traffic signals operate on a low current draw 120 VAC single phase that can be met while the engine is near idle. Older traffic signals or those operating through a junction box to accommodate multiple lights may require the higher amperage, which can be used to signal an alarm condition.

When a primary power source fails, such as after a storm, a first responder, such as a police vehicle, may be directed to a dangerous intersection. A dangerous intersection can be any crossroad where automobile drivers have become accustomed to operating traffic lights. In this example, a police officer would typically direct traffic with hand signals. By incorporation of the instant invention, the officer would run an extension cord from his vehicle to the traffic light transfer switch. The transfer switch would be used to disconnect from the primary power lines and allow input from the vehicle. The power controller would automatically adjust the vehicle engine rpm to match the required amperage of the light signals. It should be noted that the instant invention allows the light signals to continue to use the traffic signal controller that has been tailored to the operational aspects of the crossroad. The officer may stay in the vehicle, safe from inattentive drivers as well as any environmental elements.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more elements, possesses those one or more elements, but is not limited to possessing only those one or more elements. Furthermore, a device or structure that is configured in a certain way is configured in at least that way, but may also be configured in ways that are not listed.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A portable power supply for traffic signals comprising:
a vehicle having an internal combustion engine;
a 12 VDC 300 amp alternator coupled to said internal combustion engine;
a power controller comprising a governor for controlling the rpm's of said internal combustion engine;
a monitor electrically coupled to said alternator to indicate alternator voltage,
a battery bank electrically coupled to said alternator;
an inverter having an input coupled to said battery bank and a 120 VAC outlet, said inverter converting 12 VDC to 120 VAC; and
a power transfer cord having a first end securable to said inverter and a second end for securement to a traffic signal transfer switch; and
a cross-over switch for connecting the police vehicle to the traffic controller so as to prevent a back feed into the power grid;
wherein said power controller adjusting said internal combustion engine rpm's to maintain said inverter output above 20 amps and 100 VAC, whereby said vehicle provides an alternative power source for a traffic signal.

2. The power supply for traffic signals according to claim 1 wherein said inverter is 5000 W, having an output of 120 VAC at about 30 amps.

3. The power supply for traffic signals according to claim 1 wherein said 120 VAC outlet is a fixed plug mounted to an outer surface of the vehicle.

4. The power supply for traffic signals according to claim wherein said 120 VAC outlet includes an extension cable positioning a movable plug at a distal end, said extension cable secured to a retractable reel for ease of deployment and retraction of said movable plug.

5. The power supply for traffic signals according to claim wherein said battery bank is further defined as four 12V batteries placed in parallel, said batteries sized to receive voltage fluctuations from said alternator and provide a steady uninterrupted voltage to said inverter.

6. The power supply for traffic signals according to claim wherein said power controller monitors voltage output from said alternator, said inverter and said battery bank, said power controller coupled to a vehicle horn and provides alarms in the event voltage or amperage levels drop below a predetermined level.
